(19) United States
(12) Patent Application Publication
(10) Pub. No.: US 2022/0149559 A1
(43) Pub. Date: May 12, 2022

(54) MULTI-DIAMETER AND MULTI-DIRECTIONAL CABLE RETAINING ASSEMBLY

(71) Applicant: Molex, LLC, Lisle, IL (US)

(72) Inventors: Ludwig LANGE, Nuland (NL); Gabriele KRIMSHANDL, Neubiberg (DE); Matthijs VONWITTE, Holzkirchen (DE); Jörg Henning MAIROSE, Munich (DE); Mario URNER, Munich (DE); Peter George ROCHE, Eindhoven (NL); Marco STEINBRÜECK, Grasbrunn (DE)

(73) Assignee: Molex, LLC, Lisle, IL (US)

(21) Appl. No.: 17/435,505

(22) PCT Filed: Mar. 27, 2020
(86) PCT No.: PCT/US2020/025529

§ 371 Date: Sep. 1, 2021

Related U.S. Application Data
(60) Provisional application No. 62/826,043, filed on Mar. 29, 2019.

(51) Int. Cl. H01R 13/516; H01R 13/58

(52) U.S. Cl. CPC H01R 13/516; H01R 13/5841; H01R 13/5837

(57) ABSTRACT

A cable connector assembly includes lower and upper hood parts which are mated together to form a passageway therethrough in which a connector and a cable retaining assembly are mounted. The cable retaining includes a cable retaining body and a cable retainer attached thereto. The cable retaining body provides two exits and the cable retaining body can be positioned within the hood parts in a number of different orientations to change the exit path. Multiple cable retaining bodies and cable retainers can be interchangeably mounted within the hood parts.

### RELATED APPLICATIONS

This application claims priority to U.S. Provisional Application No. 62/826,043, filed Mar. 29, 2019, which is incorporated herein by reference.

### FIELD OF THE DISCLOSURE

The current disclosure relates to the field of cable connectors.

### DESCRIPTION OF RELATED ART

The current disclosure generally relates to cable connectors having a strain relief. Strain reliefs are specifically incorporated into cable connectors to absorb and transfer stress due to bending and tensile forces away from the cable to connector interface. Increased stress in these areas damage the connector and cable which can lead to the conductor breakage and the separation of the actual conductors of the cable from the connector.

In general, additional plastic or rubber members are added to the cable to cable connector interface, typically called boots. These boots prevent over-bending of the cable at the interface and also transfer incidental pulling forces applied to the cable to the connector hood parts. This essentially removes any forces from being transferred from the conductors of the cable to the actual connection terminals or contacts within the connector hood parts. The boots are typically formed as a separate operation when manufacturing the cable connector and are unique to each cable connector.

These boots are generally specific to the cable being used with each connector. In these instances, different discrete boots are needed for each specific wire. Certain individuals can appreciate a cost effective and standardized solution to this problem in which a strain relief can accommodate multiple cable sizes, provide various directional outlets and provide EMI shielding.

### BRIEF SUMMARY

According to an embodiment of the disclosure, a cable connector assembly includes lower and upper hood parts which are mated together to form a passageway therethrough in which a connector and a cable retaining assembly are mounted. The cable retaining assembly includes a cable retaining body and a cable retainer attached thereto. The cable retaining body provides two exits and the cable retaining body can be positioned within the hood parts in a number of different orientations to change the exit path. Multiple cable retaining bodies and cable retainers can be interchangeably mounted within the hood parts.

According to an embodiment of the disclosure, a cable connector assembly includes a lower hood part, an upper hood part connected to the lower hood part and forming a passageway therethrough, the passageway having a front end section and a rear end section, a connector having a plurality of electrically conductive terminals retained therein configured to be connected to conductors of a first cable, the connector mounted in the front end section of the passageway, and a cable retaining assembly mounted in the rear end section of the passageway, the cable retaining assembly including a cable retaining body and a cable retainer attached to the cable retaining body, the cable retaining body having a guideway therein forming a first exit having a centerline which is angled relative to a longitudinal axis of the cable retaining body and a second exit having a centerline which is parallel to the longitudinal axis of the cable retaining body, wherein a second cable is configured to be seated within the guideway with the cable retainer configured to engage the second cable to retain the cable within the guideway, wherein the cable retaining assembly is mountable within the passageway with the first exit proximate to the rear end of the passageway or the cable retaining assembly is mountable within the passageway with the second exit proximate to the rear end of the passageway.

According to an embodiment of the disclosure, a cable connector assembly includes a lower hood part; an upper hood part connected to the lower hood part and forming a passageway therethrough, the passageway having a front end section and a rear end section; a connector having a plurality of electrically conductive terminals retained therein configured to be connected to conductors of a first cable, the connector mounted in the front end section of the passageway; and a plurality of cable retaining assemblies, each cable retaining assembly configured to be mounted in the rear end section of the passageway, each cable retaining assembly including a cable retaining body having a guideway therein in which a second cable is configured to be seated and forming a first exit having a centerline which is longitudinally aligned with a longitudinal axis of the cable retaining body and a second exit having a centerline which is angled relative to the longitudinal axis of the cable retaining body, and each cable retaining assembly including a cable retainer configured to engage the second cable and attached to the cable retaining body, wherein each cable retaining assembly comprising a different cable retainer attached to the cable retaining body.

According to an embodiment of the disclosure, a cable retaining assembly configured to clamp a cable therein includes a lower hood part; an upper hood part connected to the lower hood part and forming a passageway therethrough, the passageway having a front end section and a rear end section; a cable retaining body including a base wall and a pair of side walls extending from the base wall thereby forming a guideway, the guideway defining a first exit which is longitudinally aligned with a longitudinal axis of the cable retaining body and a second exit which is angled relative to the longitudinal axis of the cable retaining body, wherein a cable is configured to be seated within the guideway, each side wall having a plurality of ribs extending therefrom and into the guideway; and a cable retainer attached to the cable retaining body, the cable retainer includes a platform having tags extending from opposite sides thereof, the tags being engageable with the ribs such that the cable retainer is configured to move vertically relative to the cable retaining body.

To better understand the above-described objectives, characteristics and advantages of the present disclosure, embodiments, with reference to the drawings, are provided for detailed explanations.

### BRIEF DESCRIPTION OF THE DRAWINGS

The present invention is illustrated by way of example, and not limited, in the accompanying figures in which like reference numerals indicate similar elements and in which:

FIG. 1 depicts a perspective view of a cable connector assembly which has a first embodiment of a cable retaining assembly mounted therein;

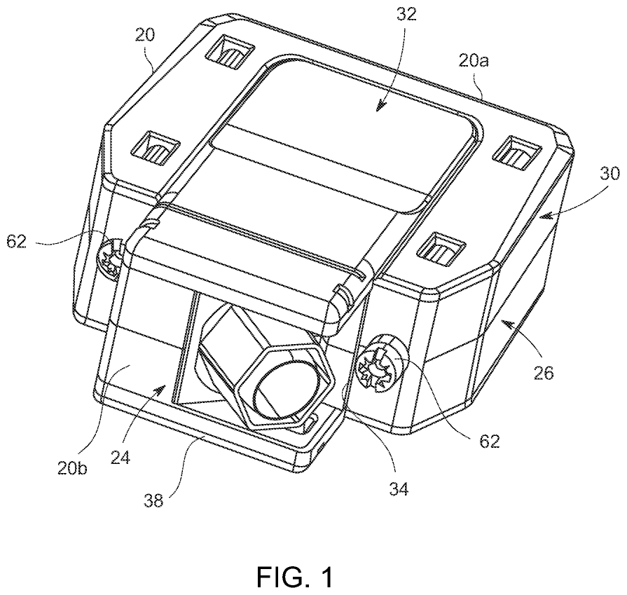

FIG. 2 depicts an exploded perspective view of the cable connector assembly and cable retaining assembly shown in FIG. 1;

FIG. 3 depicts a perspective view of the cable connector assembly with an upper cover and upper hood part removed to illustrate the first embodiment of the cable retaining assembly of FIG. 1 mounted therein and a connector mounted therein;

FIG. 4 depicts a top plan view of the cable connector assembly with the upper cover and upper hood part removed to illustrate the first embodiment of the cable retaining assembly of FIG. 1 mounted therein and the connector mounted therein;

FIG. 5 depicts a perspective view of the lower hood part of the cable connector assembly;

FIG. 6 depicts a top plan view of the lower hood part of the cable connector assembly;

FIG. 7 depicts a cross-sectional view of the cable connector assembly;

FIG. 8 depicts an exploded perspective view of the connector;

FIG. 9 depicts a top perspective view of the cable retaining assembly of FIG. 1;

FIG. 10 depicts a bottom perspective view of the cable retaining assembly of FIG. 1;

FIG. 11 depicts an exploded, top perspective view of the cable retaining assembly of FIG. 1;

FIG. 12 depicts a top plan view of a cable retaining body of the cable retaining assembly of FIG. 1;

FIG. 13 depicts a top perspective view of the cable retaining assembly of FIG. 1 in a different orientation;

FIG. 14 depicts a top perspective view of a second embodiment of the cable retaining assembly;

FIG. 15 depicts an exploded, top perspective view of the cable retaining assembly of FIG. 14;

FIG. 16 depicts a top plan view of a cable retaining body of the cable retaining assembly of FIG. 14;

FIG. 17 depicts an exploded, top perspective view of a clamp button assembly which forms part of the cable retaining assembly of FIG. 14;

FIG. 18 depicts a side elevation view of the clamp button assembly;

FIG. 19 depicts a top perspective view of a third embodiment of the cable retaining assembly;

FIG. 20 depicts an exploded, top perspective view of the cable retaining assembly of FIG. 19;

FIG. 21 depicts a top plan view of a cable retaining body of the cable retaining assembly of FIG. 19;

FIG. 22 depicts a top perspective view of a fourth embodiment of the cable retaining assembly;

FIG. 23 depicts an exploded, top perspective view of the cable retaining assembly of FIG. 22; and

FIG. 24 depicts a top plan view of a cable retaining body of the cable retaining assembly of FIG. 22.

### DETAILED DESCRIPTION

The detailed description that follows describes exemplary embodiments and is not intended to be limited to the expressly disclosed combination(s). Therefore, unless otherwise noted, features disclosed herein may be combined to form additional variations that were not otherwise shown for purposes of brevity.

While the preferred embodiment of the disclosure has been shown and described, it will be apparent to those skilled in the art that changes and modifications may be made therein without departing from the spirit of the disclosure, the scope of which is defined by the appended claims. Like members are designated by like reference characters.

Directional terms such as front, rear, horizontal, vertical and the like are used for ease in explanation, and do not denote a required orientation in use.

The appended figures illustrate an embodiment of the cable connector and it is to be understood that the disclosed embodiment is merely exemplary, which may be embodied in various forms. Therefore, specific details disclosed herein are not to be interpreted as limiting, but merely as a basis for the claims and as a representative basis for teaching one skilled in the art to variously employ the present disclosure.

A cable connector assembly 20 is provided and is configured to receive a connector 22 and a cable retaining assembly 24, 224, 324, 424 therein. Individual terminals (not shown) that pass through the connector 22 are electrically connected to a cable bundle (not shown) which is clamped by the cable retaining assembly 24, 224, 324, 424.

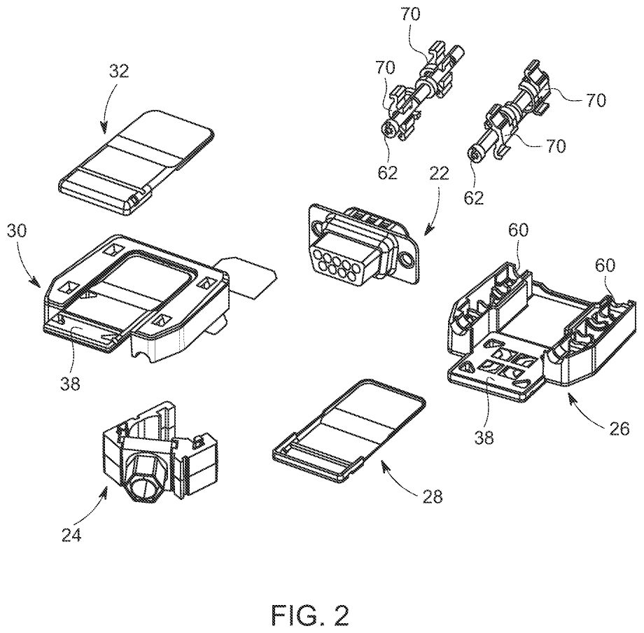

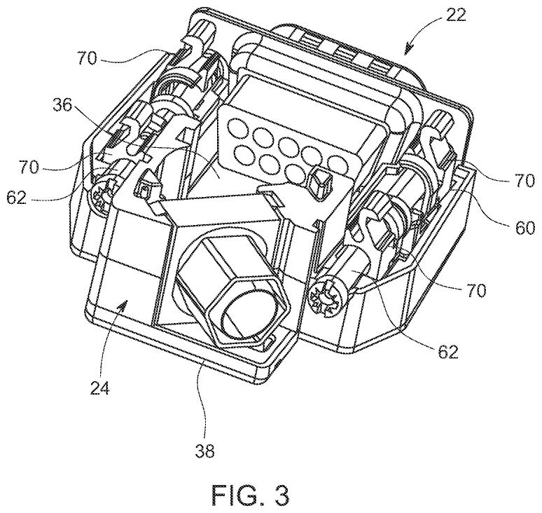

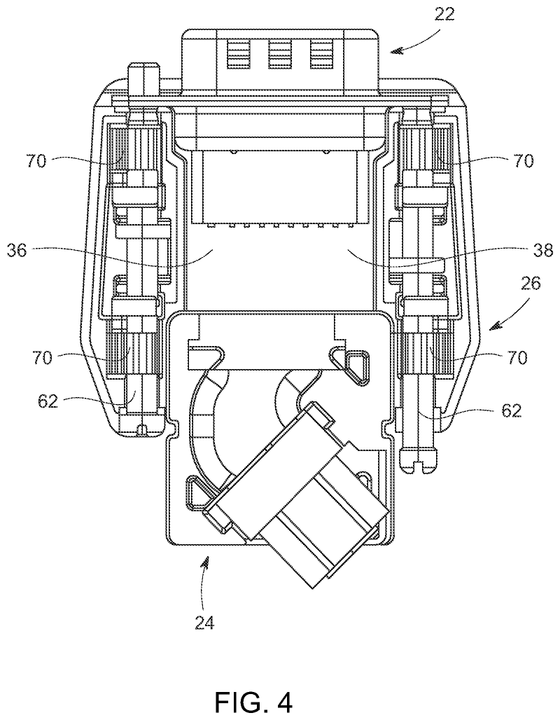

As best shown in FIG. 2, the cable connector assembly 20 includes a lower hood part 26, a lower cover 28 attached to the lower hood part 26, an upper hood part 30, and an upper cover 32 attached to the upper hood part 30. The lower and upper hood parts 26, 30 are connected together and form a passageway 34 therebetween in which the connector 22 and the cable retaining assembly 24, 224, 324, 424 are seated. The connector 22 is seated within the passageway 34 at a front or mating end 20a of the cable connector assembly 20 and the cable retaining assembly 24, 224, 324, 424 is seated within the passageway 34 at a rear or cable exit end 20b of the cable connector assembly 20. When the connector 22 and the cable retaining assembly 24, 224, 324, 424 are seated within the passageway 34, an open area 36, see FIGS. 3 and 4, is defined therebetween that provides a wire or cable management area. This open area 36 is utilized to route individual wires from respective terminals positioned in the connector 22 to a cable bundle within the cable retaining assembly 24, 224, 324, 424.

The lower and upper hood parts 26, 30 are hermaphroditic, and for ease in description, only the lower hood part 26 is described with the understanding that the components are flipped in the upper hood part 30. The lower hood part 26 has a base wall 38, and a pair of side walls 40, 42 that extend upwardly from side edges of the base wall 38 such that a recess 44 having open front and rear ends and an open top end is defined. The recess 44 in the lower hood part 26 and the recess 44 in the upper hood part 30 form the passageway 34 when the lower and upper hood parts 26, 30 are mated together as described herein.

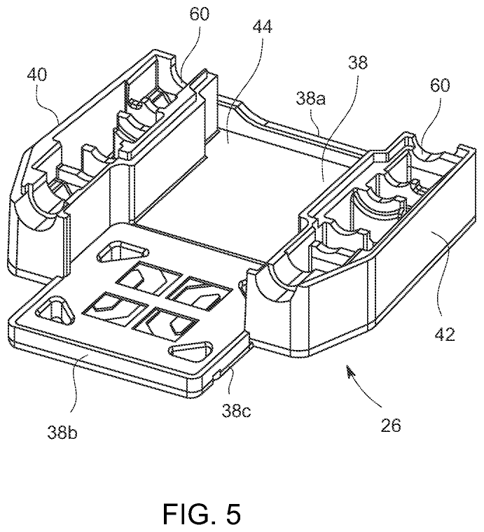

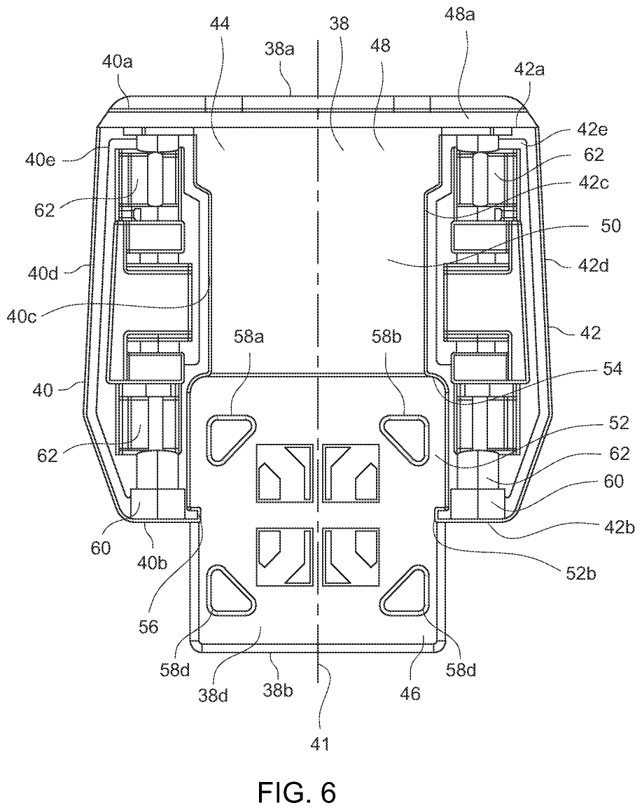

As best shown in FIGS. 5 and 6, the base wall 38 has a front end 38a and a rear end 38b, a lower surface 38c, and an upper surface 38d. The upper surface 38d forms part of the recess 44. A longitudinal axis 41 of the base wall 38 is defined from the front end 38a to the rear end 38b. A rear portion 46 of the base wall 38 extends rearwardly of the rear ends 40b, 42b of the side walls 40, 42.

The base wall 38 and the side walls 40, 42 define a front end section 48 of the recess 44, an intermediate section 50 which extends from a rear end of the front end section 48, and a rear section 52 which extends from a rear end of the intermediate section 50. The rear section 52 has a front portion 52a that is wider than the intermediate section 50 such that a shoulder 54 is formed therebetween. The rear section 52 further has a rear portion 52b that has a width that is less than the width of the front portion 52a such that a shoulder 56 is formed therebetween.

The front end section 48 of the recess 44 has a pocket 48a extending therefrom proximate to the front end 38a of the base wall 38. The upper surface 38d of the base wall 38 has a plurality of spaced apart openings 58a, 58b, 58c, 58d therein. Openings 58a, 58b are proximate to, but spaced from, the front end of the rear section 52, and openings 58c, 58d are in the rear portion 46.

Each side wall 40, 42 has a front end 40a, 42a and a rear end 40b, 42b, and inner, outer and top wall surfaces 40c, 42c, 40d, 42d, 40e, 42e extending from the front end 40a, 42a to the rear end 40b, 42b. The inner wall surfaces 40c, 42c face each other and form part of the front end section 48, the intermediate section 50, and the rear portion 52b of the recess 44.

The top wall surface 40e, 42e of each side wall 40, 42 has a fastener receiving recess 60 therein and which extends from the front end 40a, 42a to the rear end 40b, 42b. A fastener 62 is partially seated in each fastener receiving recess 60 as described herein. In an embodiment, each fastener receiving recess 60 has a pair of spaced apart passageways 64 extending downwardly therefrom and which extend in a direction that is perpendicular to the longitudinal axis 41 of the base wall 38. Each passageway 64 has a front wall, a rear wall, an inner wall 64a which is proximate to the recess 44 and extends between inner edges of the front and rear walls, and an outer wall 64b which is spaced from the inner wall 64a and extends between outer edges of the front and rear walls. In an embodiment, the front wall, the rear wall and the inner walls 64a are planar. The outer wall 64b has upper and lower wall surfaces which are parallel to each, and may be offset from each other, and a plurality of wall surfaces between the upper and lower wall surfaces which form a barb 68.

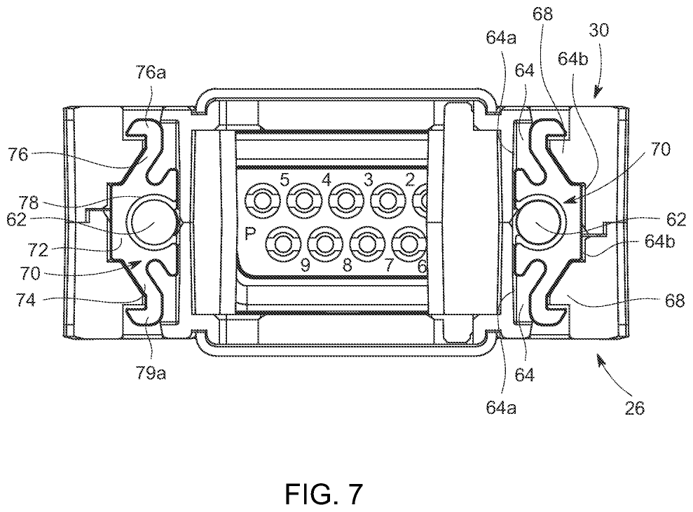

In an embodiment a snap member 70, see FIG. 7, is mounted in each passageway 64 and the snap members 70 are used to connect the lower and upper hood parts 26, 30 together. Each snap member 70 includes a main body 72, a lower arm 74 extending downward from the main body 72, and an upper arm 76 extending upward from the main body 72. The main body 72 is generally formed as a block with a fastener receiving opening 78 formed therein, which may be open to a side of the block. The fastener receiving opening 78 has a shape that is larger than a shank of the fastener 62 and may mirror the shape of the shank. Each arm 74, 76 is hook-shaped and mirrors the shape of the barb 68 such that an end portion 74a, 76b of each arm 74, 76 hooks around the barb 68 to secure the snap member 70 to the respective hood part 26, 30. The arms 74, 76 can flex relative to the main body 72.

To partially assemble the cable connector assembly 20, the fasteners 62 and the snap members 70 are seated within the fastener receiving recesses 60 in the side walls 40, 42 of the lower hood part 26. To affect this, one fastener 62 is inserted into the fastener receiving openings 78 of each snap member 70 which are to be seated within the side wall 40 of the lower hood part 26. The lower arm 74 of each snap member 70 is thereafter inserted into the passageways 64 in the side wall 40 of the lower hood part 26. The lower arm 74 of each snap member 70 flexes toward the inner walls 64a as the lower arms 74 slide along the barb 68. Once the hook-shaped lower arm 74 passes below the barb 68, the lower arm 74 resumes its original shape and the end portion 74a of the lower arm 74 engages the underside of the barb 68. This seats the fastener 62 in the fastener receiving recess 60 of the side wall 40. This process is repeated for the other fastener 62 which is mounted in the fastener receiving recess 60 of the side wall 42.

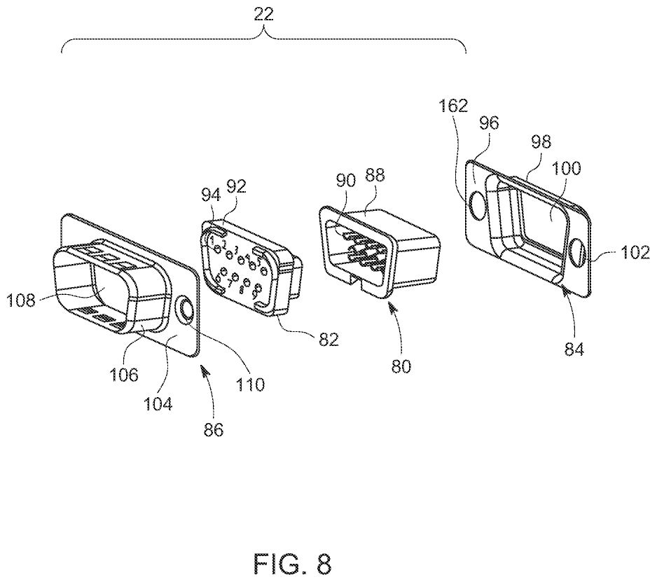

The connector 22 seats within the front end section 48 and part of the intermediate section 50 of each hood part 26, 30. As shown in FIG. 8, in an embodiment, the connector 22 is a conventional data connector having a retention portion 80 connected to a holder 82, with the retention portion 80 and the holder 82 received within parts 84, 86 of a shield assembly. The retention portion 80 includes a body 88 having a plurality of electrically conductive terminals 90 are mounted, and the holder 82 includes a body 92 having a plurality of passageways 94 extending therethrough; the terminals 90 and the passageway 94 are aligned. The part 84 of the shield assembly includes a plate 96 having a central flange 98 protruding therefrom. A central passageway 100 extends through the plate 96 and the flange 98. The retention portion 80 and the holder 82 seat within the passageway 100 and extend rearwardly therefrom. A pair of mounting apertures 102 are provided through the plate 96. The part 86 of the shield assembly includes a plate 104 having a central flange 106 protruding therefrom. A central passageway 108 extends through the plate 104 and the flange 106. The plate 104 abuts against the holder 82 to secure the retention portion 80 and the holder 82 within the passageway 100. A pair of mounting apertures 110 are provided through the plate 104 and align with mounting apertures 102. Although a data connector is shown, other types of connectors are contemplated such as power connectors and mixed layout connectors.

To partially assemble the cable connector assembly 20, the connector 22 is seated within the front end section 48 of the recess 44 of the lower hood part 26. The plates 96, 104 of the connector 22 seat within the pocket 48a in the front end section 48 of the recess 44. The fasteners 62 are moved rearward so that the fasteners 62 do not interfere with the insertion of the plates 96, 104 into the pocket 48a.

The cable retaining assembly 24, 224, 324, 424 seats within in the rear section 52 of the recess 44 of the lower hood part 26 and on the rear portion 46 of the base wall 38 of each hood part 26, 30. A number of differently formed cable retaining assemblies 24, 224, 324, 424 can be seated within the rear section 52 as described herein. In addition, each cable retaining assembly 24, 224, 324, 424 can be orientated in a variety of ways within the rear section 52 in order to change an exit path for the cable.

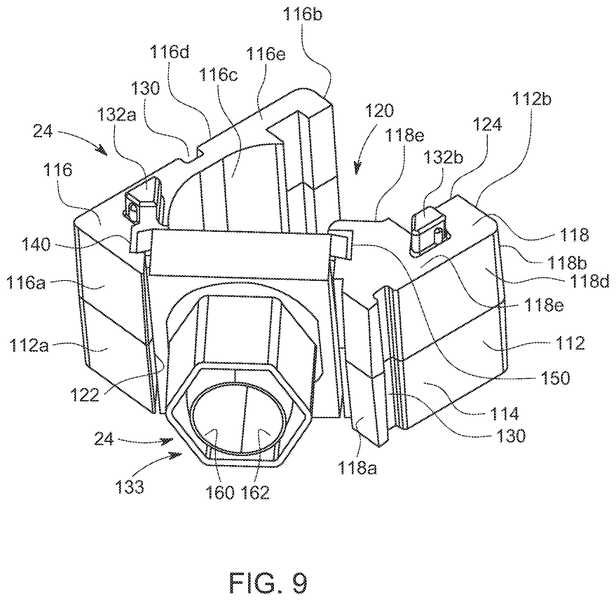

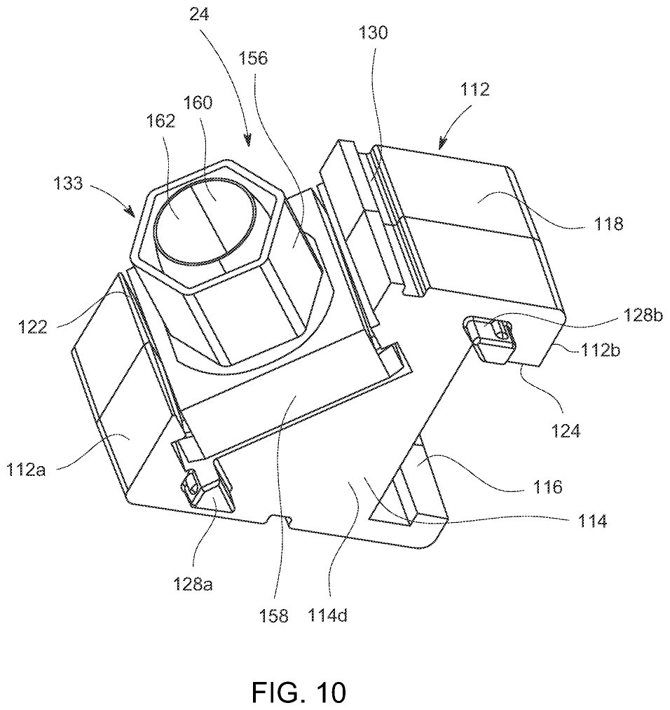

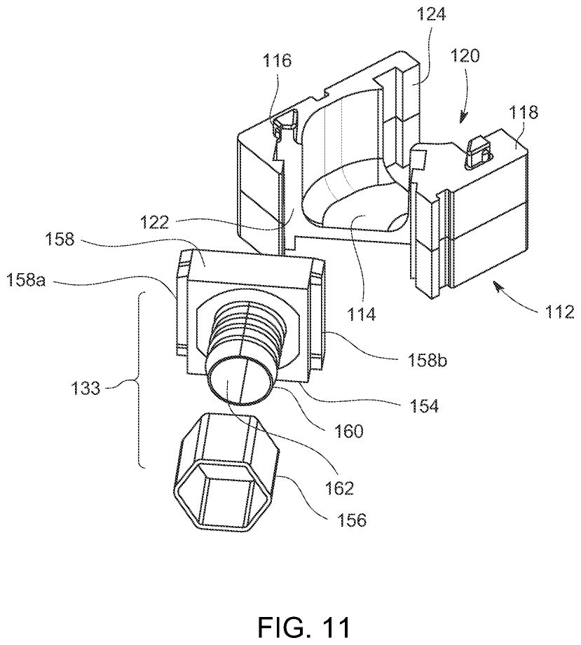

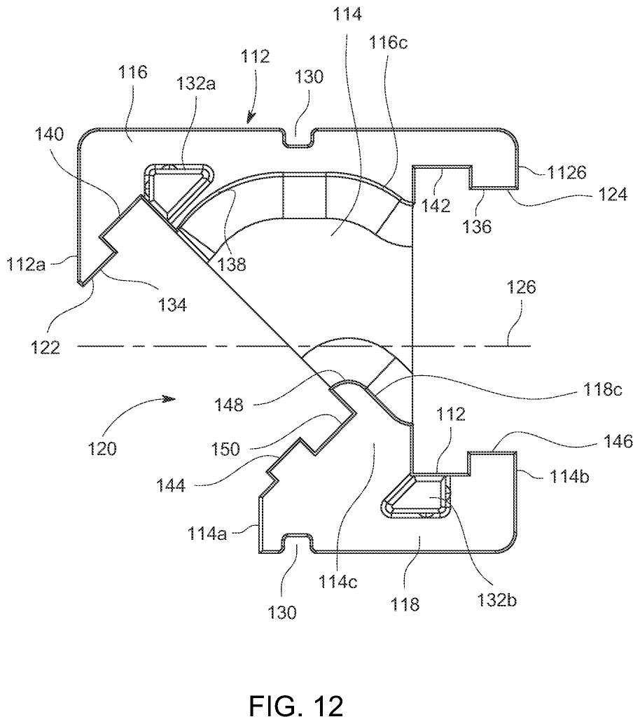

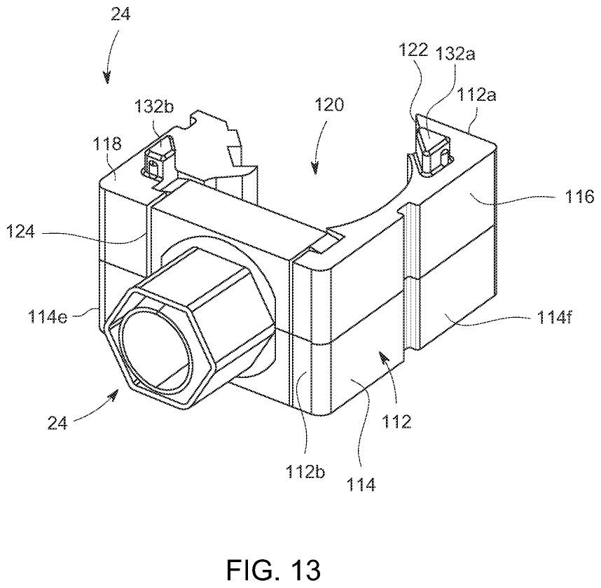

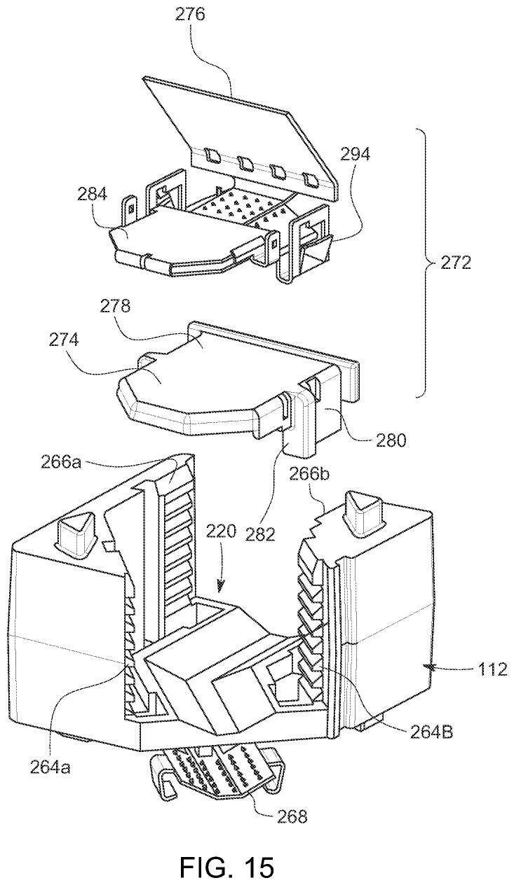

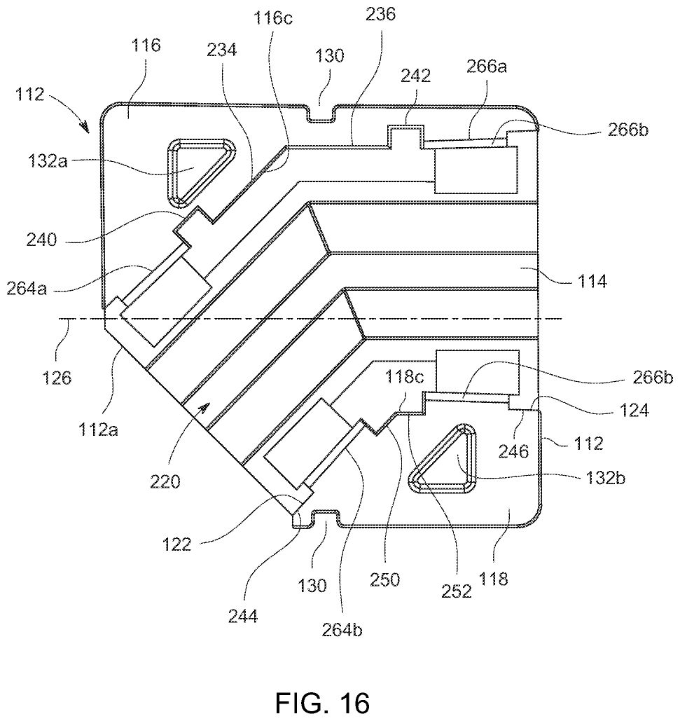

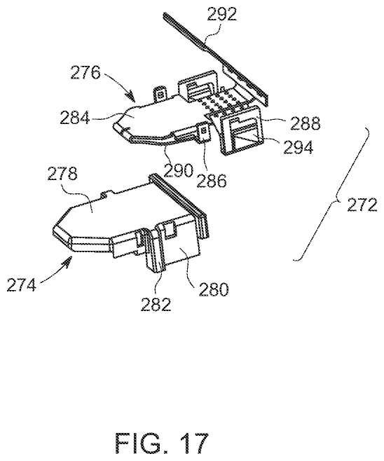

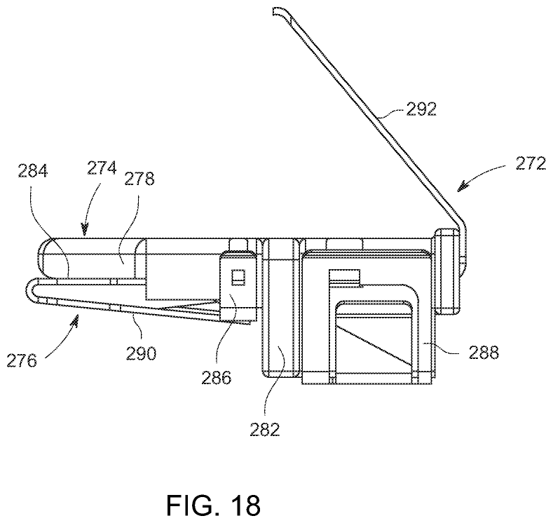

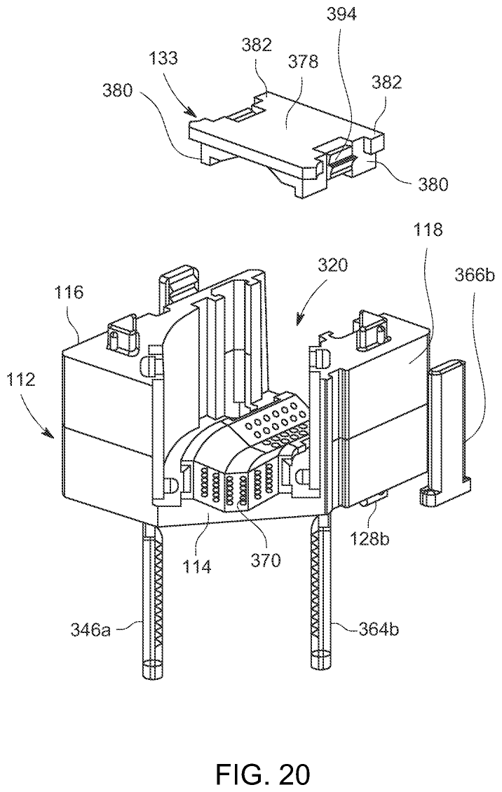

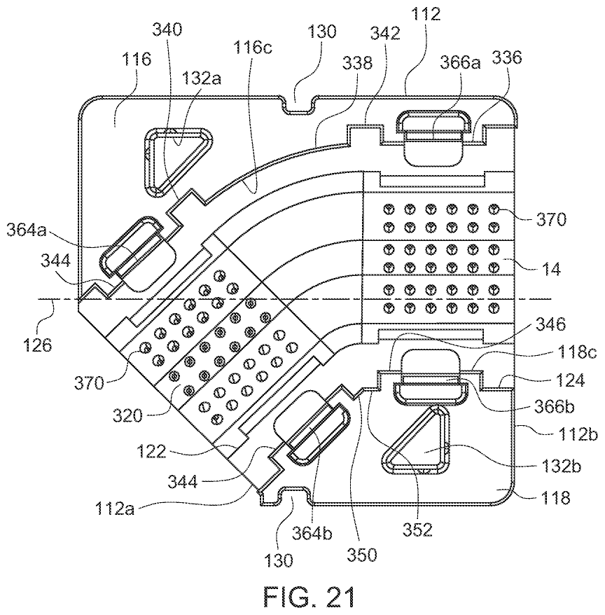

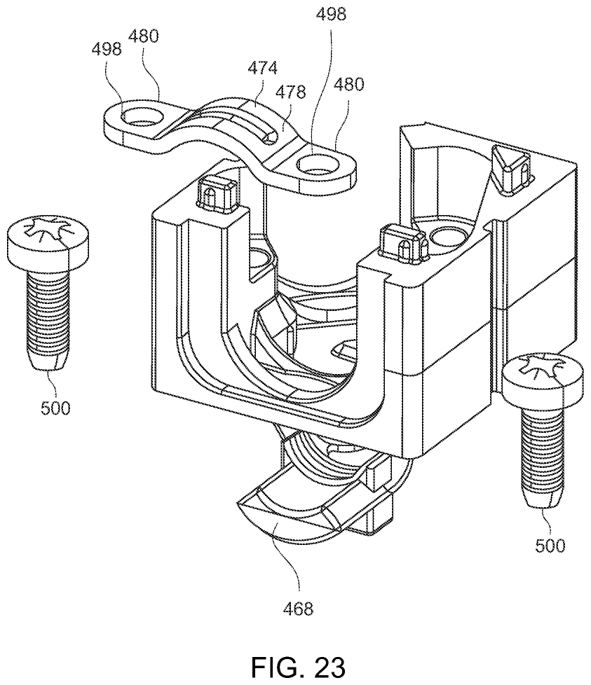

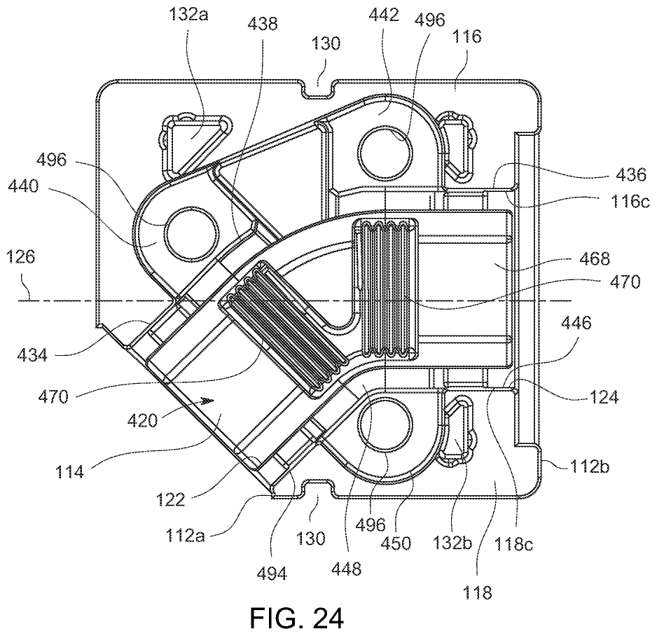

Each cable retaining assembly 24, 224, 324, 424, see FIGS. 9-24, includes a cable retaining body 112 formed from a conductive material, such as die cast aluminum. The cable retaining body 112 has a base wall 114, and a pair of side walls 116, 118 that extend upwardly from the base wall 114 such that a guideway 120, 220, 320, 420 is defined. The base wall 114 and the side walls 116, 118 define a first exit 122 of the guideway 120, 220, 320, 420 at a first end 112a of the cable retaining body 112 which has a centerline that is angled relative to a longitudinal axis 126 of the cable retaining body 112 which extends between the first end 112a and an opposite second end 112b of the cable retaining body 112. The base wall 114 and the side walls 116, 118 define a second exit 124 at the second end 112b of the cable retaining body 112 which has a centerline that is parallel to the longitudinal axis 126 of the cable retaining body 112.

The base wall 114 has a first and second end surfaces 114a, 114b, upper and lower surfaces 114c, 114d, and side surfaces 114e, 114f. The upper surface 114c forms part of the guideway 120, 220, 320, 420. A first projection 128a extends from the lower surface 114d of the base wall 114 proximate to the first end 112a of the cable retaining body 112 and underneath the side wall 116. A second projection 128b extends from the lower surface 114d of the base wall 114 proximate to the second end 112b of the cable retaining body 112 and underneath the side wall 118.

Each side wall 116, 118 has a first and second end surfaces 116a, 118a, 116b, 118b, and inner, outer and top wall surfaces 116c, 118c, 116d, 118d, 116e, 118e extending therebetween. The inner wall surfaces 116c, 118c form part of the guideway 120, 220, 320, 420. The outer wall surface 116d, 118d of each side wall 116, 118 is planar with the exception of a pocket 130 formed along the length thereof. The pocket 130 is provided at approximately the midpoint of the outer wall surface 116d of side wall 116, and the pocket 130 is provided proximate to the first end 114a of the outer wall surface 118d of side wall 118. The pockets 130 align with each other. A first projection 132a extends from the upper surface 116e of the side wall 116 proximate to the first end 116a hereof and vertically aligns with the projection 128a. A second projection 132b extends from the upper surface 118e of the side wall 118 proximate to the second end 118b thereof and vertically aligns with the projection 128b.

Each cable retaining assembly 24, 224, 324, 424 further includes a cable retainer 133 attached to the cable retaining body 112.

A first embodiment of the guideway 120 of the cable retaining assembly 24 is depicted in FIGS. 9-13.

The inner wall surface 116c of the side wall 116 has a planar first wall section 134 extending from the first end 112a of the cable retaining body 112 and which is angled relative to the longitudinal axis 126, and a planar second wall section 136 extending from the second end 112b of the cable retaining body 112 and which is parallel to the longitudinal axis 126, and a curved wall section 138 extending therebetween. In an embodiment, the first wall section 134 is angled at 45 degrees relative to the longitudinal axis 126. A first pocket 140 is provided along the height of the first wall section 134 proximate to the first end 112a and extends outwardly from the guideway 120. A second pocket 142 is provided along the height of the second wall surface 136 proximate to the second end 112b and extends outwardly from the guideway 120. The inner wall surface 118c of the side wall 118 has a planar first wall section 144 extending from the first end 112a of the cable retaining body 112 and which is angled relative to the longitudinal axis 126 and parallel to the first wall section 134, and a planar second wall section 146 extending from the second end 112b of the cable retaining body 112 and which is parallel to the longitudinal axis 126 and parallel to the first wall section 136, and a curved wall section 148 extending therebetween. In an embodiment, the first wall section 144 is angled at 45 degrees relative to the longitudinal axis 126. A first pocket 150 is provided along the height of the first wall section 144 proximate to the first end 112a and extends outwardly from the guideway 120. A second pocket 152 is provided along the height of the second wall surface 146 proximate to the second end 112b and extends outwardly from the guideway 120. The first pockets 140, 150 align with each other, and the second pockets 142, 152 align with each other.

In a first orientation, the cable retaining body 112 is seated on the base wall 38 such that the first exit 122 is at the rear end 38b of the base wall 38 and the cable retainer 133 is seated within the pockets 140, 150. The cable retaining body 112 seats within the rear section 52 of the recess 44 of the lower hood part 26 and on the rear portion 46 of the base wall 38. To affect this, projection 128a seats within opening 58c and projection 128b seats within opening 58b. The shoulder 56 of the side wall 40 seats within the pocket 130 in the side wall 116, and the shoulder 56 of the side wall 42 seats within the pocket 130 in the side wall 118. The longitudinal axes 41, 126 align with each other. The end 112a of the of the cable retaining body 112 aligns with the rear end 38b of the base wall 38. In this first orientation, the centerline of the first exit 122 is angled relative to the aligned longitudinal axes 41, 126.

In a second orientation, the cable retaining body 112 is seated on the base wall 38 such that the first exit 122 is again at the rear end 38b of the base wall 38 and the cable retainer 133 is seated within the pockets 140, 150. The cable retaining body 112 seats within the rear section 52 of the recess 44 of the lower hood part 26 and on the rear portion 46 of the base wall 38. To affect this, projection 132a seats within opening 58d and projection 132b seats within opening 58a. The shoulder 56 of the side wall 42 seats within the pocket 130 in the side wall 116, and the shoulder 56 of the side wall 40 seats within the pocket 130 in the side wall 118. The longitudinal axes 41, 126 align with each other. The end 112a of the of the cable retaining body 112 aligns with the rear end 38b of the base wall 38. In this second orientation, the centerline of the first exit 122 is again angled relative to the aligned longitudinal axes 41, 126.

In a third orientation, the cable retaining body 112 is seated on the base wall 38 such that the second exit 124 is at the rear end 38b of the base wall 38 and the cable retainer 133 is seated within the pockets 142, 152. The cable retaining body 112 seats within the rear section 52 of the recess 44 of the lower hood part 26 and on the rear portion 46 of the base wall 38. To affect this, the protrusion 1128a seats within opening 58b, projection 128b seats within opening 58a, the shoulder 56 of the side wall 42 seats within the pocket 130 in the side wall 116, and the shoulder 56 of the side wall 40 seats within the pocket 130 in the side wall 118. Or to affect this, projection 132a seats within opening 58a, projection 132b seats within opening 58d, the shoulder 56 of the side wall 40 seats within the pocket 130 in the side wall 116, and the shoulder 56 of the side wall 42 seats within the pocket 130 in the side wall 118. The longitudinal axes 41, 126 align with each other. The end 112a of the of the cable retaining body 112 aligns with the rear end 38b of the base wall 38. In this third orientation, the centerline of the second exit 124 is parallel to the aligned longitudinal axes 41, 126.

The cable retainer 133 which is used with this variation of the cable retaining body 112 includes a crimp body 154 and a crimp sleeve 156.

The crimp body 154 includes a platform 158 having a cable receiving flange 160 extending from one side thereof. A passageway 162 extends through the platform 158 and the cable receiving flange 160. A pair of vertical mounting ribs 158a, 158b extend outwardly from sides of the platform 158 and are received in the pockets 140, 150 or in the pockets 142, 152.

The crimp sleeve 156 is a multi-sided member that is formed of metal. In an embodiment, the crimp sleeve 156 is hexagonal. The crimp sleeve 156 seats over the cable receiving flange 160 of the crimp body 154.

The mounting ribs 158a, 158b are seated in the pockets 140, 150 in the first and second orientations, and are seated in the pockets 142, 152 in the third orientation. The cable retainer 133 and the connector 22 are separated from each other by the open area 36. Thereafter, the cable is passed through the passageway 162 of the crimp body 154 and passed through the remainder of the guideway 120 and into the half of the open area 36 formed by the lower hood part 26. Alternatively, the cable can be passed through the crimp body 154 prior to seating the crimp body 154 in the cable retaining body 112. In the first and second orientations, terminated ends of the cable bundle extend outward from the second end 112b of the cable retaining body 112 and into the half of the open area 36 formed by the lower hood part 26. In the third orientation, terminated ends of the cable bundle extend outward from the first end 112a of the cable retaining body 112 and into the half of the open area 36 formed by the lower hood part 26. The terminated ends of the cable bundle in the half of the open area 36 formed by the lower hood part 26 are then electrically connected to the terminals extending through the connector 22.

Next, the crimp sleeve 156 is crimped by a suitable crimping mechanism to crimp the crimp sleeve 156 onto the cable receiving flange 160, thereby crimping the cable receiving flange 160 onto the cable bundle.

Thereafter, the upper hood part 30 is attached to the lower hood part 26 by seating the upper arms 76 of the snap members 70 into the passageways 64 in the side walls 40, 42 of the upper hood part 30 until the hook-shaped ends 76a of the upper arms 76 engage the barbs 68 in the upper hood part 30. This seats the fasteners 62 in the fastener receiving recesses 60 of the upper hood part 30. When the hood parts 26, 30 are mated, the pockets 48a align with each other and capture the plates 96, 104 of the connector 22 therein, the front end sections 48 of the recesses 44 align with each other, the intermediate sections 50 of the recesses 44 align with each other, and the rear sections 52 of the recesses 44 align with each other to form the passageway 34. The fastener receiving recess 60 in the side walls 116, 118 align with each other. The fasteners 62 are moved forward to extend through the aligned apertures 102, 110 in the plates 96, 104 of the connector 22 to enable the cable connector assembly 20 to be mounted to another component (not shown).

In the first and second orientations, the cable bundle exits the cable connector assembly 20 through the rear end 112a at an angle to the longitudinal axis 126 of the cable connector assembly 20. Since the hood parts 26, 30 are hermaphroditic, the cable connector assembly 20 can be flipped 180 degrees when in the first orientation so that the cable bundle exits to the desired side of the cable connector assembly 20. Since the hood parts 26, 30 are hermaphroditic, the cable connector assembly 20 can be flipped 180 degrees when in the second orientation so that the cable bundle exits to the desired side of the cable connector assembly 20.

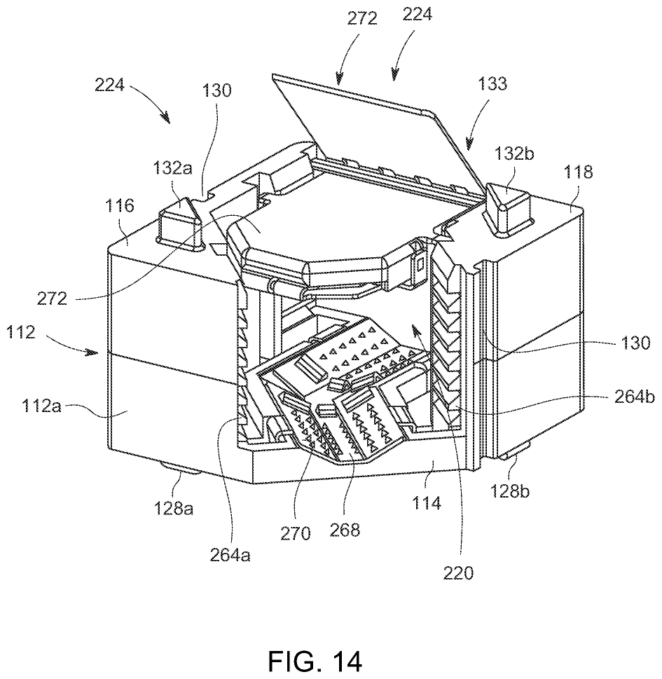

A second embodiment of the guideway 220 of the cable retaining assembly 24 is depicted in FIGS. 14-18.

The inner wall surface 116c of the side wall 116 has a planar first wall section 234 extending from the first end 112a of the cable retaining body 112 and which is angled relative to the longitudinal axis 126, and a planar second wall section 236 extending from the first wall section 234 to the second end 112b of the cable retaining body 112, and which is parallel to the longitudinal axis 126. In an embodiment, the first wall section 234 is angled at 45 degrees relative to the longitudinal axis 126. A first pocket 240 is provided along the height of the first wall section 234 at approximately the midpoint thereof and extends outwardly from the guideway 220. A second pocket 242 is provided along the height of the second wall surface 236 at approximately the midpoint thereof and extends outwardly from the guideway 220. The inner wall surface 118c of the side wall 118 has a planar first wall section 244 extending from the first end 112a of the cable retaining body 112 and which is angled relative to the longitudinal axis 126 and parallel to the first wall section 234, and a planar second wall section 246 extending from the first wall section 244 to the second end 112b of the cable retaining body 112 and which is parallel to the longitudinal axis 126 and parallel to the first wall section 236. In an embodiment, the first wall section 244 is angled at 45 degrees relative to the longitudinal axis 126. A first pocket 250 is provided along the height of the first wall section 244 proximate to the second wall section 246 and extends outwardly from the guideway 220. A second pocket 252 is provided along the height of the second wall surface 246 proximate to the first wall section 244 and extends outwardly from the guideway 220. The first pockets 240, 250 align with each other, and the second pockets 242, 252 align with each other.

The first wall section 234 has plurality of ribs 264a extending therefrom. The ribs 264a are rearward of the pocket 240. The ribs 264a form a series of steps. The ribs 264a may be integrally formed with the first wall section 234. The first wall section 244 has plurality of ribs 264b extending therefrom. The ribs 264b are rearward of the pocket 250. The ribs 264b form a series of steps. The ribs 264b may be integrally formed with the first wall section 244. The ribs 246a, 264b align with each other.

The second wall section 236 has plurality of ribs 266a extending therefrom. The ribs 266a are forward of the pocket 242. The ribs 266a form a series of steps. The ribs 266a may be integrally formed with the second wall section 236. The second wall section 246 has plurality of ribs 266b extending therefrom. The ribs 266b are forward of the pocket 252. The ribs 266b form a series of steps. The ribs 266b may be integrally formed with the second wall section 246. The ribs 246a, 266b align with each other.

In a first orientation, the cable retaining body 112 is seated on the base wall 38 such that the first exit 122 is at the rear end 38b of the base wall 38 and the cable retainer 133 is seated within the pockets 240, 250 and engaged with the ribs 264a, 264b as described herein. The cable retaining body 112 seats within the rear section 52 of the recess 44 of the lower hood part 26 and on the rear portion 46 of the base wall 38. To affect this, projection 128a seats within opening 58c and projection 128b seats within opening 58b. The shoulder 56 of the side wall 40 seats within the pocket 130 in the side wall 116, and the shoulder 56 of the side wall 42 seats within the pocket 130 in the side wall 118. The longitudinal axes 41, 126 align with each other. The end 112a of the of the cable retaining body 112 aligns with the rear end 38b of the base wall 38. In this first orientation, the centerline of the first exit 122 is angled relative to the aligned longitudinal axes 41, 126.

In a second orientation, the cable retaining body 112 is seated on the base wall 38 such that the first exit 122 is again at the rear end 38b of the base wall 38 and the cable retainer 133 is seated within the pockets 240, 250 and engaged with the ribs 264a, 264b as described herein. The cable retaining body 112 seats within the rear section 52 of the recess 44 of the lower hood part 26 and on the rear portion 46 of the base wall 38. To affect this, projection 132a seats within opening 58d and projection 132b seats within opening 58a. The shoulder 56 of the side wall 42 seats within the pocket 130 in the side wall 116, and the shoulder 56 of the side wall 40 seats within the pocket 130 in the side wall 118. The longitudinal axes 41, 126 align with each other. The end 112a of the of the cable retaining body 112 aligns with the rear end 38b of the base wall 38. In this second orientation, the centerline of the first exit 122 is again angled relative to the aligned longitudinal axes 41, 126.

In a third orientation, the cable retaining body 112 is seated on the base wall 38 such that the second exit 124 is at the rear end 38b of the base wall 38 and the cable retainer 133 is seated within the pockets 242, 152 and engaged with the ribs 266a, 266b as described herein. The cable retaining body 112 seats within the rear section 52 of the recess 44 of the lower hood part 26 and on the rear portion 46 of the base wall 38. To affect this, the protrusion 1128a seats within opening 58b, projection 128b seats within opening 58a, the shoulder 56 of the side wall 42 seats within the pocket 130 in the side wall 116, and the shoulder 56 of the side wall 40 seats within the pocket 130 in the side wall 118. Or to affect this, projection 132a seats within opening 58a, projection 132b seats within opening 58d, the shoulder 56 of the side wall 40 seats within the pocket 130 in the side wall 116, and the shoulder 56 of the side wall 42 seats within the pocket 130 in the side wall 118. The longitudinal axes 41, 126 align with each other. The end 112a of the of the cable retaining body 112 aligns with the rear end 38b of the base wall 38. In this third orientation, the centerline of the second exit 124 is parallel to the aligned longitudinal axes 41, 126.

The base wall 114 may have a plurality of spikes integrally formed thereon, or may have a grounding spring 268 attached thereto which may have a plurality of spikes 270 extending therefrom. In an embodiment, the grounding spring 268 is secured to the upper surface 114c of the base wall 114 and provides a grounding path from a ground return element of the cable to the cable retaining body 112. The plurality of spikes 270 engage portions of the cable including the ground return element.

The cable retainer 133 which is used with this variation of the cable retaining body 112 includes a clamp button assembly 272 having a clamp button 274 and a clamping spring 276. The clamp button assembly 272 is movably attached to the side walls 116, 118 of the cable retaining body 112 and received within the guideway 120 of the cable retaining body 112. The clamp button assembly 272 can translate in a vertical direction creating a cable exit section of the cable retaining body 112 having various sized opening for the cable. The clamp button assembly 272 translates vertically and engages the cable in a clamping manner to securely retain the cable to the cable retaining body 112, therefore minimizes strain on the cable.

The clamp button 274 is a rigid member and is formed of a platform 278 having an upper surface and a lower surface which may be planar, a pair of legs 280 extending downward from side edges thereof, and a vertical mounting rib 282 extending downward from side edges thereof.

The clamping spring 276 is formed from an electrically conductive material. The clamping spring 276 includes a planar main body portion 284, a first pair of legs 286 extending from side edges thereof, a second pair of legs 288 extending from side edges thereof, a lower arm portion 290 extending from a first end of the main body portion 284 and at an angle relative thereto, and an upper arm portion 292 extending from a second end of the main body portion 284 and at an angle relative thereto. The lower arm portion 290 substantially overlaps the main body portion 284 and extends between the pairs of legs 286, 288 and can flex toward the main body portion 284. The upper arm portion 292 partially overlaps the main body portion 284 and can flex toward the main body portion 284. Each leg 288 has a tag 294 which extends outwardly and upwardly therefrom, and at an angle.

In an embodiment and as shown, the main body portion 284 seats below the platform 278 and the upper arm portion 292 extends above and over the platform 278. The legs 288 seat over the legs 280. Each leg 286 and the sides of the platform 278 having mating structure which secures the clamping spring 276 to the clamp button 274. In an example, each leg 286 has a projection which seats within in recess in the sides of the platform 278.

To assemble the cable with the cable retaining body 112 and the cable retainer 133 formed by the clamp button assembly 272 in this variation, the clamp button assembly 272 is first attached to the cable retaining body 112. When the cable retaining body 112 is to be positioned in the first or second orientations, the tags 294 are engaged with the ribs 264a, 264b and the mounting ribs 282 are positioned within the pockets 340, 350. When the cable retaining body 112 is to be positioned in the third orientation, the tags 294 are engaged with the ribs 266a, 266b and the mounting ribs 282 are positioned within the pockets 342, 352. In each orientation, the lower arm portion 290 faces the base wall 114 of the cable retaining body 112. Thereafter, the cable is passed between the lower arm portion 290 and the base wall 114 and passed through the remainder of the guideway 120.

The operator then pushes against the platform 278 of the clamp button 274 into the cable retaining body 112. As the clamp button assembly 272 is pushed into the cable retaining body 112, the tags 294 engage the ribs 264a, 264b or 266a, 266b in a ratcheting manner and the clamp button assembly 272 moves downward towards the cable creating a clamping force on the cable when the lower arm portion 290 engages the cable. The assembled cable retaining body 112 and clamp button assembly 272 are then inserted into the rear section of the guideway 220 of the lower hood part 26.

The terminated ends of the cable are positioned within the half of the open area 36 formed by the lower hood part 26. In the first and second orientations, terminated ends of the cable bundle extend outward from the second end 112b of the cable retaining body 112 and into the half of the open area 36 formed by the lower hood part 26. In the third orientation, terminated ends of the cable bundle extend outward from the first end 112a of the cable retaining body 112 and into the half of the open area 36 formed by the lower hood part 26. The terminated ends of the cable bundle in the half of the open area 36 formed by the lower hood part 26 are then electrically connected to the terminals extending through the connector 22.

Thereafter, the upper hood part 30 is attached to the lower hood part 26 by seating the upper arms 76 of the snap members 70 into the passageways 64 in the side walls 40, 42 of the upper hood part 30 until the hook-shaped ends 76a of the upper arms 76 engage the barbs 68 in the upper hood part 30. This seats the fasteners 62 in the fastener receiving recesses 60 of the upper hood part 30. When the hood parts 26, 30 are mated, the pockets 48a align with each other and capture the plates 96, 104 of the connector 22 therein, the front end sections 48 of the recesses 44 align with each other, the intermediate sections 50 of the recesses 44 align with each other, and the rear sections 52 of the recesses 44 align with each other to form the passageway 34. The fastener receiving recess 60 in the side walls 116, 118 align with each other. The upper arm portion 290 can flex when the upper arm portion 290 contacts the upper hood part 30 and maintains contact with the upper hood part 30 and provides electromagnetic (EMI) shielding. The fasteners 62 are moved forward to extend through the aligned apertures 102, 110 in the plates 96, 104 of the connector 22 to enable the cable connector assembly 20 to be mounted to another component (not shown).

In the first and second orientations, the cable bundle exits the cable connector assembly 20 through the rear end 112a at an angle to the longitudinal axis 126 of the cable connector assembly 20. Since the hood parts 26, 30 are hermaphroditic, the cable connector assembly 20 can be flipped 180 degrees when in the first orientation so that the cable bundle exits to the desired side of the cable connector assembly 20. Since the hood parts 26, 30 are hermaphroditic, the cable connector assembly 20 can be flipped 180 degrees when in the second orientation so that the cable bundle exits to the desired side of the cable connector assembly 20.

In some embodiments, as the second hood member 30 is mated to the first hood member 26, the second hood member 30 engages the upper arm portion 290 of the clamping spring 276 and further pushes the clamp button assembly 272 into the cable retaining body 112 and onto the cable.

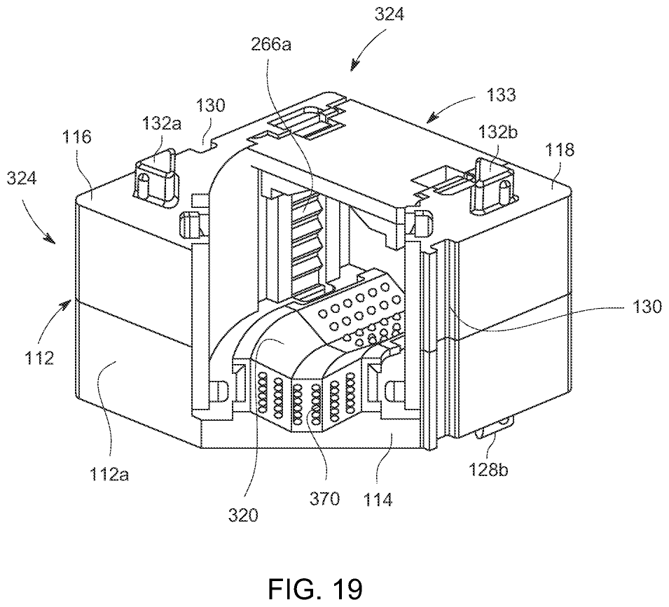

A third embodiment of the guideway 320 of the cable retaining assembly 24 is depicted in FIGS. 19-21.

The inner wall surface 116c of the side wall 116 has a planar first wall section 334 extending from the first end 112a of the cable retaining body 112 and which is angled relative to the longitudinal axis 126, and a planar second wall section 336 extending from the second end 112b of the cable retaining body 112 and which is parallel to the longitudinal axis 126, and a curved wall section 338 extending therebetween. In an embodiment, the first wall section 334 is angled at 45 degrees relative to the longitudinal axis 126. A first pocket 340 is provided along the height of the first wall section 334 proximate to the curved wall section 338 and extends outwardly from the guideway 320. A second pocket 342 is provided along the height of the second wall surface 336 proximate to the curved wall section 338 and extends outwardly from the guideway 320. The inner wall surface 118c of the side wall 118 has a planar first wall section 344 extending from the first end 112a of the cable retaining body 112 and which is angled relative to the longitudinal axis 126 and parallel to the first wall section 334, and a planar second wall section 346 extending from the first wall section 344 to the second end 112b of the cable retaining body 112 and which is parallel to the longitudinal axis 126 and parallel to the first wall section 336. In an embodiment, the first wall section 344 is angled at 45 degrees relative to the longitudinal axis 126. A first pocket 350 is provided along the height of the first wall section 344 proximate to the second wall section 346 and extends outwardly from the guideway 320. A second pocket 352 is provided along the height of the second wall surface 346 proximate to the first wall section 344 and extends outwardly from the guideway 320. The first pockets 340, 350 align with each other, and the second pockets 342, 352 align with each other.

The first wall section 334 has plurality of ribs 364a extending therefrom. The ribs 364a are rearward of the pocket 340. The ribs 364a form a series of steps. In this embodiment, the ribs 364a are formed as a separate member and attached to the first wall section 334. The first wall section 344 has plurality of ribs 364b extending therefrom. The ribs 364b are rearward of the pocket 350. The ribs 364b form a series of steps. In this embodiment, the ribs 364b are formed as a separate member and attached to the first wall section 344. The ribs 346a, 364b align with each other.

The second wall section 336 has plurality of ribs 366a extending therefrom. The ribs 366a are forward of the pocket 342. The ribs 366a form a series of steps. In this embodiment, the ribs 366a are formed as a separate member and attached to the second wall section 336. The second wall section 346 has plurality of ribs 366b extending therefrom. The ribs 366b are forward of the pocket 352. The ribs 366b form a series of steps. In this embodiment, the ribs 366b are formed as a separate member and attached to the second wall section 346. The ribs 346a, 366b align with each other.

In a first orientation, the cable retaining body 112 is seated on the base wall 38 such that the first exit 122 is at the rear end 38b of the base wall 38 and the cable retainer 133 is seated within the pockets 340, 350 and engaged with the ribs 364a, 364b as described herein. The cable retaining body 112 seats within the rear section 52 of the recess 44 of the lower hood part 26 and on the rear portion 46 of the base wall 38. To affect this, projection 128a seats within opening 58c and projection 128b seats within opening 58b. The shoulder 56 of the side wall 40 seats within the pocket 130 in the side wall 116, and the shoulder 56 of the side wall 42 seats within the pocket 130 in the side wall 118. The longitudinal axes 41, 126 align with each other. The end 112a of the of the cable retaining body 112 aligns with the rear end 38b of the base wall 38. In this first orientation, the centerline of the first exit 122 is angled relative to the aligned longitudinal axes 41, 126.

In a second orientation, the cable retaining body 112 is seated on the base wall 38 such that the first exit 122 is again at the rear end 38b of the base wall 38 and the cable retainer 133 is seated within the pockets 340, 350 and engaged with the ribs 364a, 364b as described herein. The cable retaining body 112 seats within the rear section 52 of the recess 44 of the lower hood part 26 and on the rear portion 46 of the base wall 38. To affect this, projection 132a seats within opening 58d and projection 132b seats within opening 58a. The shoulder 56 of the side wall 42 seats within the pocket 130 in the side wall 116, and the shoulder 56 of the side wall 40 seats within the pocket 130 in the side wall 118. The longitudinal axes 41, 126 align with each other. The end 112a of the of the cable retaining body 112 aligns with the rear end 38b of the base wall 38. In this second orientation, the centerline of the first exit 122 is again angled relative to the aligned longitudinal axes 41, 126.

In a third orientation, the cable retaining body 112 is seated on the base wall 38 such that the second exit 124 is at the rear end 38b of the base wall 38 and the cable retainer 133 is seated within the pockets 342, 352 and engaged with the ribs 366a, 366b as described herein. The cable retaining body 112 seats within the rear section 52 of the recess 44 of the lower hood part 26 and on the rear portion 46 of the base wall 38. To affect this, the protrusion 1128a seats within opening 58b, projection 128b seats within opening 58a, the shoulder 56 of the side wall 42 seats within the pocket 130 in the side wall 116, and the shoulder 56 of the side wall 40 seats within the pocket 130 in the side wall 118. Or to affect this, projection 132a seats within opening 58a, projection 132b seats within opening 58d, the shoulder 56 of the side wall 40 seats within the pocket 130 in the side wall 116, and the shoulder 56 of the side wall 42 seats within the pocket 130 in the side wall 118. The longitudinal axes 41, 126 align with each other. The end 112a of the of the cable retaining body 112 aligns with the rear end 38b of the base wall 38. In this third orientation, the centerline of the second exit 124 is parallel to the aligned longitudinal axes 41, 126.

The base wall 114 has a plurality of spikes 370 integrally formed thereon. The plurality of spikes 370 engage portions of the cable including the ground return element.

The cable retainer 133 which is used with this variation of the cable retaining body 112 includes a clamp button 374 which is movably attached to the side walls 116, 118 of the cable retaining body 112 and received within the guideway 320 of the cable retaining body 112. The clamp button 374 can translate in a vertical direction creating a cable exit section of the cable retaining body 112 having various sized opening for the cable. The clamp button 374 translates vertically and engages the cable in a clamping manner to securely retain the cable to the cable retaining body 112, therefore minimizes strain on the cable.

The clamp button 374 is a rigid member and is formed of a platform 378 having an upper surface and a lower surface which may be planar, a pair of legs 380 extending downward from side edges thereof, and a vertical mounting rib 382 extending from side edges thereof. Each leg 380 has a tag 394 which extends outwardly and upwardly therefrom, and at an angle. The lower surface of the platform 378 has a plurality of spikes integrally formed thereon. The plurality of spikes 370 engage portions of the cable.

To assemble the cable with the cable retaining body 112 and the cable retainer 133 formed by the clamp button 374 in this variation, the clamp button 374 is first attached to the cable retaining body 112. When the cable retaining body 112 is to be positioned in the first or second orientations, the tags 394 are engaged with the ribs 364a, 364b and the mounting ribs 382 are positioned within the pockets 340, 350. When the cable retaining body 112 is to be positioned in the third orientation, the tags 394 are engaged with the ribs 366a, 366b and the mounting ribs 382 are positioned within the pockets 342, 352. In each orientation, the lower surface of the platform 378 faces the base wall 114 of the cable retaining body 112. Thereafter, the cable is passed between the lower surface of the platform 378 and the base wall 114 and passed through the remainder of the guideway 120.

The operator then pushes against the platform 378 into the cable retaining body 112. As the clamp button 374 is pushed into the cable retaining body 112, the tags 394 engage the ribs 364a, 364b or 366a, 366b in a ratcheting manner and the clamp button 374 moves downward towards the cable creating a clamping force on the cable when the lower surface of the platform 378 engages the cable. The assembled cable retaining body 112 and clamp button 374 are then inserted into the rear section of the guideway 320 of the lower hood part 26.

The terminated ends of the cable are positioned within the half of the open area 36 formed by the lower hood part 26. In the first and second orientations, terminated ends of the cable bundle extend outward from the second end 112b of the cable retaining body 112 and into the half of the open area 36 formed by the lower hood part 26. In the third orientation, terminated ends of the cable bundle extend outward from the first end 112a of the cable retaining body 112 and into the half of the open area 36 formed by the lower hood part 26. The terminated ends of the cable bundle in the half of the open area 36 formed by the lower hood part 26 are then electrically connected to the terminals extending through the connector 22.

Thereafter, the upper hood part 30 is attached to the lower hood part 26 by seating the upper arms 76 of the snap members 70 into the passageways 64 in the side walls 40, 42 of the upper hood part 30 until the hook-shaped ends 76a of the upper arms 76 engage the barbs 68 in the upper hood part 30. This seats the fasteners 62 in the fastener receiving recesses 60 of the upper hood part 30. When the hood parts 26, 30 are mated, the pockets 48a align with each other and capture the plates 96, 104 of the connector 22 therein, the front end sections 48 of the recesses 44 align with each other, the intermediate sections 50 of the recesses 44 align with each other, and the rear sections 52 of the recesses 44 align with each other to form the passageway 34. The fastener receiving recess 60 in the side walls 116, 118 align with each other. The fasteners 62 are moved forward to extend through the aligned apertures 102, 110 in the plates 96, 104 of the connector 22 to enable the cable connector assembly 20 to be mounted to another component (not shown).

In the first and second orientations, the cable bundle exits the cable connector assembly 20 through the rear end 112a at an angle to the longitudinal axis 126 of the cable connector assembly 20. Since the hood parts 26, 30 are hermaphroditic, the cable connector assembly 20 can be flipped 180 degrees when in the first orientation so that the cable bundle exits to the desired side of the cable connector assembly 20. Since the hood parts 26, 30 are hermaphroditic, the cable connector assembly 20 can be flipped 180 degrees when in the second orientation so that the cable bundle exits to the desired side of the cable connector assembly 20.

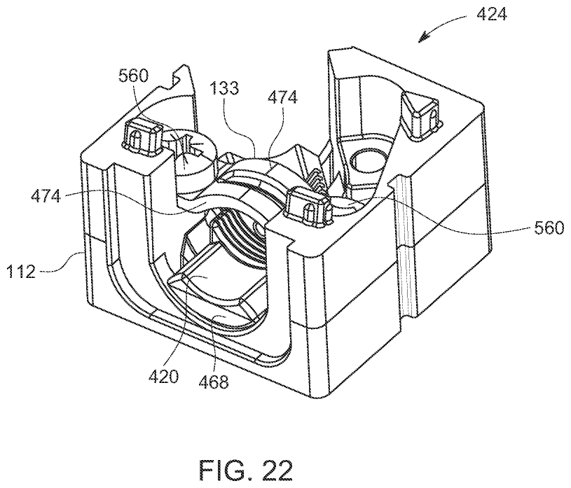

A fourth embodiment of the guideway 420 of the cable retaining assembly 24 is depicted in FIGS. 22-24.

The inner wall surface 116c of the side wall 116 has a planar first wall section 434 extending from the first end 112a of the cable retaining body 112 and which is angled relative to the longitudinal axis 126, and a planar second wall section 436 extending from the second end 112b of the cable retaining body 112 and which is parallel to the longitudinal axis 126, and a curved wall section 438 extending therebetween. In an embodiment, the first wall section 434 is angled at 45 degrees relative to the longitudinal axis 126. A first pocket 440 is provided in the first wall section 434 proximate to the curved wall section 438 and extends outwardly from the guideway 420. A second pocket 442 is provided in the second wall surface 436 proximate to the curved wall section 438 and extends outwardly from the guideway 420. The inner wall surface 118c of the side wall 118 has a planar first wall section 444 extending from the first end 112a of the cable retaining body 112 and which is angled relative to the longitudinal axis 126 and parallel to the first wall section 434, and a planar second wall section 446 extending from the second end 112b of the cable retaining body 112, which is parallel to the longitudinal axis 126 and parallel to the second wall section 436, and a curved wall section 448 extending therebetween. In an embodiment, the first wall section 444 is angled at 45 degrees relative to the longitudinal axis 126. A pocket 450 is provided in the curved wall section 448 and extends outwardly from the guideway 420. The pockets 440, 450 align with each other, and the pockets 442, 450 align with each other. Each pocket 440, 442, 450 has a threaded fastener receiving hole 496 therein.

In a first orientation, the cable retaining body 112 is seated on the base wall 38 such that the first exit 122 is at the rear end 48b of the base wall 38 and the cable retainer 133 is seated within the pockets 440, 450 as described herein. The cable retaining body 112 seats within the rear section 52 of the recess 44 of the lower hood part 26 and on the rear portion 46 of the base wall 38. To affect this, projection 128a seats within opening 58c and projection 128b seats within opening 58b. The shoulder 56 of the side wall 40 seats within the pocket 130 in the side wall 116, and the shoulder 56 of the side wall 42 seats within the pocket 130 in the side wall 118. The longitudinal axes 41, 126 align with each other. The end 112a of the of the cable retaining body 112 aligns with the rear end 48b of the base wall 38. In this first orientation, the centerline of the first exit 122 is angled relative to the aligned longitudinal axes 41, 126.

In a second orientation, the cable retaining body 112 is seated on the base wall 38 such that the first exit 122 is again at the rear end 48b of the base wall 38 and the cable retainer 133 is seated within the pockets 440, 450. The cable retaining body 112 seats within the rear section 52 of the recess 44 of the lower hood part 26 and on the rear portion 46 of the base wall 38. To affect this, projection 132a seats within opening 58d and projection 132b seats within opening 58a. The shoulder 56 of the side wall 42 seats within the pocket 130 in the side wall 116, and the shoulder 56 of the side wall 40 seats within the pocket 130 in the side wall 118. The longitudinal axes 41, 126 align with each other. The end 112a of the of the cable retaining body 112 aligns with the rear end 48b of the base wall 38. In this second orientation, the centerline of the first exit 122 is again angled relative to the aligned longitudinal axes 41, 126.

In a third orientation, the cable retaining body 112 is seated on the base wall 38 such that the second exit 124 is at the rear end 48b of the base wall 38 and the cable retainer 133 is seated within the pockets 442, 450. The cable retaining body 112 seats within the rear section 52 of the recess 44 of the lower hood part 26 and on the rear portion 46 of the base wall 38. To affect this, the protrusion 1128a seats within opening 58b, projection 128b seats within opening 58a, the shoulder 56 of the side wall 42 seats within the pocket 130 in the side wall 116, and the shoulder 56 of the side wall 40 seats within the pocket 130 in the side wall 118. Or to affect this, projection 132a seats within opening 58a, projection 132b seats within opening 58d, the shoulder 56 of the side wall 40 seats within the pocket 130 in the side wall 116, and the shoulder 56 of the side wall 42 seats within the pocket 130 in the side wall 118. The longitudinal axes 41, 126 align with each other. The end 112a of the of the cable retaining body 112 aligns with the rear end 48b of the base wall 38. In this third orientation, the centerline of the second exit 124 is parallel to the aligned longitudinal axes 41, 126.

The base wall 114 may have a plurality of spikes integrally formed thereon, or may have a grounding member 468 attached thereto which may have a plurality of spikes 470 extending therefrom. In an embodiment, the grounding member 468 is secured to the upper surface 114c of the base wall 114 and provides a grounding path from a ground return element of the cable to the cable retaining body 112. The plurality of spikes 470 engage portions of the cable including the ground return element.

The cable retainer 133 which is used with this variation of the cable retaining body 112 includes a clamp button 474 which is movably attached to the side walls 116, 118 of the cable retaining body 112 and received within the guideway 420 of the cable retaining body 112. The clamp button 474 can translate in a vertical direction creating a cable exit section of the cable retaining body 112 having various sized opening for the cable. The clamp button 474 translates vertically and engages the cable in a clamping manner to securely retain the cable to the cable retaining body 112, therefore minimizes strain on the cable.

The clamp button 474 is a rigid member and is formed of a platform 478 having an upper surface and a lower surface which may be curved, a pair of mounting arms 480 extending from side edges thereof. Each mounting arms 480 has a threaded opening 498 therethrough. A fastener 500 is mounted through each threaded opening 498 of the clamp button 474.

To assemble the cable with the cable retaining body 112 and the cable retainer 133 formed by the clamp button 474 in this variation, the clamp button 474 is first attached to the cable retaining body 112. When the cable retaining body 112 is to be positioned in the first or second orientations, the fasteners 500 are engaged with the threaded openings 496 in the pockets 440, 450 and the mounting arms 480 are positioned within the pockets 440, 450. When the cable retaining body 112 is to be positioned in the third orientation, the fasteners 500 are engaged with the threaded openings 496 in the pockets 442, 450 and the mounting arms 480 are positioned within the pockets 442, 450. In each orientation, the lower surface of the platform 478 faces the base wall 114 of the cable retaining body 112. Thereafter, the cable is passed between the lower surface of the platform 478 and the base wall 114 and passed through the remainder of the guideway 120.

The operator then rotates the fasteners 500 which causes the platform 478 to move into the cable retaining body 112. The clamp button 474 moves downward towards the cable creating a clamping force on the cable when the lower surface of the platform 478 engages the cable. The assembled cable retaining body 112 and clamp button 474 are then inserted into the rear section of the guideway 420 of the lower hood part 26.

The terminated ends of the cable are positioned within the half of the open area 36 formed by the lower hood part 26. In the first and second orientations, terminated ends of the cable bundle extend outward from the second end 112b of the cable retaining body 112 and into the half of the open area 36 formed by the lower hood part 26. In the third orientation, terminated ends of the cable bundle extend outward from the first end 112a of the cable retaining body 112 and into the half of the open area 36 formed by the lower hood part 26. The terminated ends of the cable bundle in the half of the open area 36 formed by the lower hood part 26 are then electrically connected to the terminals extending through the connector 22.

Thereafter, the upper hood part 30 is attached to the lower hood part 26 by seating the upper arms 76 of the snap members 70 into the passageways 64 in the side walls 40, 42 of the upper hood part 30 until the hook-shaped ends 76a of the upper arms 76 engage the barbs 68 in the upper hood part 30. This seats the fasteners 62 in the fastener receiving recesses 60 of the upper hood part 30. When the hood parts 26, 30 are mated, the pockets 48a align with each other and capture the plates 96, 104 of the connector 22 therein, the front end sections 48 of the recesses 44 align with each other, the intermediate sections 50 of the recesses 44 align with each other, and the rear sections 52 of the recesses 44 align with each other to form the passageway 34. The fastener receiving recess 60 in the side walls 116, 118 align with each other. The fasteners 62 are moved forward to extend through the aligned apertures 102, 110 in the plates 96, 104 of the connector 22 to enable the cable connector assembly 20 to be mounted to another component (not shown).

In the first and second orientations, the cable bundle exits the cable connector assembly 20 through the rear end 112a at an angle to the longitudinal axis 126 of the cable connector assembly 20. Since the hood parts 26, 30 are hermaphroditic, the cable connector assembly 20 can be flipped 180 degrees when in the first orientation so that the cable bundle exits to the desired side of the cable connector assembly 20. Since the hood parts 26, 30 are hermaphroditic, the cable connector assembly 20 can be flipped 180 degrees when in the second orientation so that the cable bundle exits to the desired side of the cable connector assembly 20.

Accordingly, since a number of differently formed cable retaining assembly 24, 224, 324, 424 can be used with the same hood parts 26, 30, this reduces the manufacturing cost to the manufacturer since only a single set of hood parts 26, 30 need to be molded.

The arms 74, 76 of each snap member 70 can be released from the barbs 68 by the operator inserting a tool (not shown) into the passageway 64 from outside of the cable connector assembly 20.

As an alternative to the snap members 70 attaching the lower and upper hood parts 26, 30 together, fasteners such as screws can be screwed through both hood parts 26, 30.

The lower and upper covers 28, 32 are hermaphroditic. The lower cover 28 has lower and upper surfaces which may be substantially planar, but may have ridges, indentations and the like formed thereon. Mating features are formed on the lower hood part 26 and the lower cover 28 for connecting the lower hood part 26 and the lower cover 28 together. Likewise, the upper cover 32 has lower and upper surfaces which may be substantially planar, but may have ridges, indentations and the like formed thereon. Mating features are formed on the upper hood part 30 and the upper cover 32 for connecting the upper hood part 30 and the upper cover 32 together. The covers 28, 32 may be of a variety of colors and can easily swapped out by the operator. Indicia may be provided on the covers 28, 32.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A cable connector assembly comprising:
a lower hood part;
an upper hood part connected to the lower hood part and forming a passageway therethrough, the passageway having a front end section and a rear end section;
a connector having a plurality of electrically conductive terminals retained therein configured to be connected to conductors of a first cable, the connector mounted in the front end section of the passageway; and
a cable retaining assembly mounted in the rear end section of the passageway, the cable retaining assembly including a cable retaining body and a cable retainer attached to the cable retaining body, the cable retaining body having a guideway therein forming a first exit having a centerline which is angled relative to a longitudinal axis of the cable retaining body and a second exit having a centerline which is parallel to the longitudinal axis of the cable retaining body, wherein a second cable is configured to be seated within the guideway with the cable retainer configured to engage the second cable to retain the cable within the guideway, wherein the cable retaining assembly is mountable within the passageway with the first exit proximate to the rear end of the passageway or the cable retaining assembly is mountable within the passageway with the second exit proximate to the rear end of the passageway.

2. The cable connector assembly of claim 1, wherein an open area of the passageway is provided between the cable retaining assembly and the connector.

3. The cable connector assembly of claim 1, wherein the centerline of the first exit is angled relative to the longitudinal axis of the cable retaining body at an angle of 45 degrees.

4. The cable connector assembly of claim 1, wherein
the guideway of the cable retaining body is formed by a base wall and a pair of side walls extending from the base wall, each side wall having a plurality of ribs extending therefrom and into the guideway; and
the cable retainer includes a platform having tags extending from opposite sides thereof, the tags being engageable with the ribs such that the cable retainer is configured to move vertically relative to the cable retaining body.

5. The cable connector assembly of claim 4, wherein the ribs are formed as a separate piece and attached to the cable retaining body.

6. The cable connector assembly of claim 4, wherein at least one of the platform and the base wall has a plurality of spikes extending therefrom which are engageable with the second cable.

7. The cable connector assembly of claim 4, wherein
the tags of the cable retainer are formed on a spring attached to the platform, the spring having a main body portion engaged with the platform, and an upper arm portion extending from the main body portion, the upper arm portion configured to be flexed relative to the main body portion, the tags being engageable with the ribs such that the cable retainer is configured to move vertically relative to the cable retaining body.

8. The cable connector assembly of claim 1, wherein
the guideway of the cable retaining body is formed by a base wall and a pair of side walls extending from the base wall, each side wall having a plurality of ribs extending therefrom and into the guideway; and
the cable retainer includes a platform and a pair of fasteners attaching the platform to the cable retaining body, wherein rotation of the fasteners causes movement of the cable retainer relative to the cable retaining body.

9. The cable connector assembly of claim 1, wherein
the guideway of the cable retaining body is formed by a base wall and a pair of side walls extending from the base wall, each side wall having a first pocket proximate to the first end of the passageway and a second pocket proximate to the second end of the passageway; and
the cable retainer includes a platform and a cable receiving flange extending from one side thereof, a passageway extending through the platform and the cable receiving flange, wherein the platform is configured to be received within one of first pockets and the second pockets, and a crimp sleeve mounted on the cable receiving flange.

10. The cable connector assembly of claim 1, wherein the lower hood part and the upper hood part are hermaphroditic.

11. The cable connector assembly of claim 10, wherein and the centerline of the second exit is angled relative to the longitudinal axis of the cable retaining body at an angle of 45 degrees.

12. The cable connector assembly of claim 1, further comprising an upper cover attached to the upper hood part and a lower cover attached to the lower hood part, wherein the upper and lower covers can be colored in a variety of colors.

13. The cable connector assembly of claim 1, further comprising a snap member mounted to the lower hood part and to the upper hood part, the snap member having a central body, a lower hook-shaped arm extending from the central body which releasably engages a barb on the lower hood part, an upper hook-shaped arm extending from the central body which releasably engages a barb on the upper hood part, and a fastener extending through the central body and through the connector.

14. A cable connector assembly comprising:
a lower hood part;
an upper hood part connected to the lower hood part and forming a passageway therethrough, the passageway having a front end section and a rear end section;
a connector having a plurality of electrically conductive terminals retained therein configured to be connected to conductors of a first cable, the connector mounted in the front end section of the passageway; and
a plurality of cable retaining assemblies, each cable retaining assembly configured to be mounted in the rear end section of the passageway, each cable retaining assembly including a cable retaining body having a guideway therein in which a second cable is configured to be seated and forming a first exit having a centerline which is longitudinally aligned with a longitudinal axis of the cable retaining body and a second exit having a centerline which is angled relative to the longitudinal axis of the cable retaining body, and each cable retaining assembly including a cable retainer configured to engage the second cable and attached to the cable retaining body, wherein each cable retaining assembly comprising a different cable retainer attached to the cable retaining body.

15. The cable connector assembly of claim 14, wherein each cable retaining assembly can be mounted within the passageway with the first exit proximate to the rear end of the passageway or the cable retaining assembly can be mounted within the passageway with the second exit proximate to the rear end of the passageway.

16. The cable connector assembly of claim 15, wherein and the centerline of the second exit is angled relative to the longitudinal axis of the cable retaining body at an angle of 45 degrees.

17. The cable connector assembly of claim 14, wherein the lower hood part and the upper hood part are hermaphroditic.

18. The cable connector assembly of claim 17, wherein and the centerline of the second exit is angled relative to the longitudinal axis of the cable retaining body at an angle of 45 degrees.

19. The cable connector assembly of claim 14, further comprising an upper cover attached to the upper hood part and a lower cover attached to the lower hood part, wherein the upper and lower covers can be colored in a variety of colors.

20. The cable connector assembly of claim 14, further comprising a snap member mounted to the lower hood part and to the upper hood part, the snap member having a central body, a lower hook-shaped arm extending from the central body which releasably engages a barb on the lower hood part, an upper hook-shaped arm extending from the central body which releasably engages a barb on the upper hood part, and a fastener extending through the central body and through the connector.

21. A cable retaining assembly configured to clamp a cable therein comprising:
a lower hood part;
an upper hood part connected to the lower hood part and forming a passageway therethrough, the passageway having a front end section and a rear end section;
a cable retaining body including a base wall and a pair of side walls extending from the base wall thereby forming a guideway, the guideway defining a first exit which is longitudinally aligned with a longitudinal axis of the cable retaining body and a second exit which is angled relative to the longitudinal axis of the cable retaining body, wherein a cable is configured to be seated within the guideway, each side wall having a plurality of ribs extending therefrom and into the guideway; and
a cable retainer attached to the cable retaining body, the cable retainer includes a platform having tags extending from opposite sides thereof, the tags being engageable with the ribs such that the cable retainer is configured to move vertically relative to the cable retaining body.

22. The cable retaining assembly of claim 21, wherein the tags of the cable retainer are formed on a spring attached to the platform, the spring having a main body portion engaged with the platform, and an upper arm portion extending from the main body portion, the upper arm portion configured to be flexed relative to the main body portion.
